(19) United States
(12) Patent Application Publication
(10) Pub. No.: US 2015/0246676 A1
(43) Pub. Date: Sep. 3, 2015

(54) PERSONAL PROFILES BASED SYSTEM FOR SPEED LIMIT ENFORCING AND METHODS OF USE THEREOF

(71) Applicant: Yakov Keren, Petah Tikva (IL)

(72) Inventor: Yakov Keren, Petah Tikva (IL)

(21) Appl. No.: 14/429,323

(22) PCT Filed: Sep. 17, 2013
(86) PCT No.: PCT/IL2013/050791

§ 371 Date: Mar. 18, 2015

(30) Foreign Application Priority Data
Sep. 19, 2012 (IL) 221987

(51) Int. Cl. B60W 30/14; F02D 9/02; G01S 19/13

(52) U.S. Cl. CPC B60W 30/146; G01S 19/13; F02D 9/02; F02D 2009/0201

(57) ABSTRACT

A speed-limit-enforcing system for enforcing speed limit on a vehicle hosting the system, and methods of using thereof. The system includes a speed-limit controller, a drivers' profile DB, a driver-identifier and a throttle controller. The speed-limit profile of each driver is predefined by a master user, wherein a driver may not alter his speed-limit profile. The driver-identifier identifies the current driver, wherein the drivers' profile DB includes a speed-limit profile of that current driver. The speed-limit controller, being a personal mobile device, derives a current speed limit from rules defined in the speed-limit profile of the current driver, wherein the speed-limit controller activates the throttle controller to limit the fuel supply to the engine of the vehicle, such that the current velocity of the vehicle, provided by an external source, does not exceed the current speed limit.

### FIELD OF THE INVENTION

The present invention relates to vehicle speed limit enforcement, and more specifically, to active, onboard systems and methods that enable enforcing the local road speed limit on the vehicle hosting the system.

### BACKGROUND OF THE INVENTION

Excessive vehicle speed is a major cause of accidents, which may result in loss of life and property. Road signs indicating a speed limit often do not deter careless drivers.

Prior art systems for enforcing a speed limit include U.S. Pat. No. 6,462,675, given to Scott Humphrey et al., discloses a position of a vehicle is detected by a receiver at the vehicle from a global positioning system. A speed limit associated with the position is determined from a centralized database accessible via a wireless network. An actual speed of the vehicle at the detected position is compared with the determined speed limit for the detected position, such that if it is determined that the actual speed exceeds the determined speed limit at the detected position, the driver may be alerted.

U.S. Pat. No. 6,188,949, given to Stefan Hahn et al., discloses a method and arrangement for controlling the longitudinal velocity of a motor vehicle is provided with a continuous determination of the vehicle position and controlling of the longitudinal velocity while defining a desired velocity defining value and/or velocity defining limit value as a function of the determined vehicle position. By using corresponding velocity defining devices, velocity data are detected by way of the actual value and/or a set desired value and/or a set limit value of the longitudinal vehicle velocity as a function of the vehicle position. The desired velocity defining value and/or velocity defining limit value is determined from the velocity data detected for the respective vehicle position during one or several preceding drives. The detected velocity data themselves and/or the desired defining value data or defining limit value data are stored in a retrievable manner.

U.S. Pat. No. 6,728,605, given to David Lash et al., discloses a vehicle speed monitoring device which enables a driver to enter a speed tolerance profile that represents the driver's personal travel speed preferences and which alerts the driver when the vehicle speed falls outside the speed tolerance profile. Specifically, the speed tolerance profile consists of a number of speed tolerance ranges, each associated with a particular posted speed limit. As the vehicle travels through various map zones, the applicable posted speed limit is determined using a customized GPS map. The device determines the vehicle location, speed and the posted speed limit and then compares the vehicle speed using a running average to see whether vehicle speed is within the driver's speed tolerance profile and if not, the device provides the driver with a visual and/or audible warning according to the driver's operational preferences.

A system is desired for enforcing the speed limit upon drivers, so that it may be impossible to exceed the permitted speed, even if the driver wants to.

However, the system should be flexible: the speed limit may change with location; on various roads, a different speed limit may apply. Furthermore, it may be desirable to allow pedal travel in low gear, where more gas will result in higher acceleration (which may be permitted), rather than excessive speed.

There is a need to, and it would be advantageous to have a flexible system and method for limiting the maximum speed of a vehicle by the rate of fuel supplied to the engine of the vehicle. Such a system enables a car owner, for example, to define speed limits constraints to some or all allowed drivers of his/her vehicle. It should be noted that the define speed limits constraints may be different then the legal speed limits.

There are a number of ways to control the rate of fuel supplied to the engine of the vehicle, known in the art. Such control can be performed by the vehicle computer controlling the opening of the throttle or the fuel injectors. Another way known in the art to control the rate of fuel supplied to the engine of the vehicle, is using an add-on mechanical apparatus—an accelerating-pedal-control apparatus.

Such accelerating-pedal-control apparatuses are described in Israeli patent application IL 2215576, filed on Aug 21, 2012, which is incorporated by reference for all purposes as if fully set forth herein. An example of an accelerating-pedal-control apparatus is shown in FIGS. 1-5 (prior art). FIG. 1 is a perspective view of an accelerating-pedal-control apparatus 80, mounted onto the cabin floor 22 of a vehicle 20, wherein a pedal 52 of a pedal assembly 50 is free to move down in the full height of the depression range—H, and wherein the accelerating pedal is in a non-depressed state. FIG. 2 is a perspective view of accelerating-pedal-control apparatus 80, wherein the accelerating pedal is in a fully-depressed state.

To limit the depression range of pedal 52, a stopper 86 is controllably disposed such that a sliding element 88, when reaching stopper 86, prevents pedal 52 from being further depressed. It can be observed (see FIG. 2) that although pedal 52 is fully depressed, sliding element 88 is still distant from stopper 86. Hence, in this case, the driver is free to drive normally, whereas the full height of the pedal's depression range (H) is available to him.

FIG. 3 is a perspective view of the accelerating-pedal-control apparatus 80, wherein accelerating pedal 52 is limited in moving down by an intermediate height of the depression range, and wherein accelerating pedal 52 is in a non-depressed state. FIG. 4 is a perspective view of the accelerating-pedal-control apparatus 80, wherein accelerating pedal 52 is in a fully-depressed state and wherein sliding element 88, moved by motion-conveying rod 70, is blocked by stopper 86 to thereby prevent accelerating pedal 52 from being further depressed.

FIG. 5 is a perspective view of accelerating-pedal-control apparatus 80, wherein accelerating pedal 52 is fully limited in moving down. In this state, accelerating pedal 52 is at the highest most position, wherein sliding element 88 is disposed adjacent to stopper 86. Thereby, in this state, stopper 86 prevents a driver from pressing down accelerating pedal 52. Optionally, to override the blockage of sliding element 88 by stopper 86, the driver may use at least preconfigured excessive force F₂, to unlock stopper 86.

### SUMMARY OF THE INVENTION

The principal intentions of the present invention include providing a system and methods for enforcing the desired road speed limit on the host vehicle. While such a system may bring comfort to worrying parents of driving youngsters, such a system may also provide the comfort of driving at a steady speed without worrying about over speeding, both on highway and on city streets.

Another aspect of the present invention is to enable entering personal profiles for each driver of a particular car. The system identifies the driver, preferably via biometric data, wherein speed-limit rules are tailored to each driver. Optionally statistical data of the driving behavior of each driver may be collected and analyzed.

According to the teachings of the present invention, there is provided a speed-limit-enforcing system for enforcing a speed limit on a vehicle hosting the system, the system including a speed-limit controller, a drivers' profile DB, a driver-identifier and a throttle controller. The speed-limit controller is adapted to activate the driver-identifier, such as biometric-driver-recognition device, a voice recognition device, a face recognition device, iris recognition device or any other uniquely identifying device known in the art, to identify the current driver of the vehicle and wherein the drivers' profile DB includes a speed-limit profile of the current driver.

The speed-limit controller derives a current speed limit from rules defined in the speed-limit profile of the current driver, wherein the speed-limit controller activates the throttle controller to limit the fuel supply to the engine of the vehicle, such that the current velocity of the vehicle, provided by an external source, does not exceed the current speed limit.

Preferably, the speed-limit-enforcing system further includes one or more warning devices, wherein when the current velocity of the vehicle exceeds the current speed limit, the speed-limit controller activates at least one of the warning devices to warn the current driver. At least one of the warning devices is selected from the group including: a speaker, a light, a display.

Preferably, at least one of the warning devices is activated in an intensity that is directly related to the difference in speed between the current velocity of the vehicle and the current speed limit.

Optionally, the external source is a GPS unit, wherein the speed-limit controller retrieves the current velocity of the vehicle and the geographical location of the current road, on which road the vehicle is being driven on, from the GPS unit.

Optionally, the speed-limit-enforcing system further includes a map-memory-storage containing map data, including the maximum legal speed limit of the current road, wherein at least one of the rules, defined in the speed-limit profile of the current driver, relates to the maximum legal speed limit of the current road. The map-memory-storage may be a local device or a remote database.

Optionally, at least one of the rules defined in the speed-limit profile of the current driver, relates to a velocity selected from the group including the maximum legal speed allowed in the country and the maximum urban speed allowed, if urban/country geographical data location is known.

Optionally, the throttle controller is an accelerating-pedal-control apparatus, and wherein the speed-limit controller is adapted to activate an electric motor for setting the position of a stopper, to thereby limit the depression range of the accelerator pedal. When the ignition key of the vehicle is turned off, the speed-limit controller is adapted to activate the electric motor to raise the accelerating pedal to upper most state.

Optionally, the speed-limit-enforcing system further includes display for displaying data. Optionally, the display is a detachable device, and wherein the speed-limit-enforcing system is adapted to operate even if the display is detached from the system. Optionally, the display is a touch screen, enabling entering input to the speed-limit controller, wherein the touch-screen enables entering a driver's speed-limit profile.

Optionally, the biometric-driver-recognition device is a fingerprint reader.

Optionally, the drivers' profile DB resides in a remote server, for example, a cloud server.

Optionally, the speed-limit controller is a personal user-smart-mobile device, having a driver-application running thereon, and the speed-limit-enforcing system further includes a master-smart-mobile device, having a master-application running thereon, owned by the master user. The personal user-smart-mobile device and the master-smart-mobile device are typically the personal smart phones of the drivers and the master user, respectively. The master-application facilitates the master user to turn on an activation mode.

Optionally, in a smart mobile devices based system, the external source is a GPS unit integrated into the personal user-smart-mobile device and the master-smart-mobile device, and wherein the speed-limit controller retrieves the current velocity of the vehicle and the geographical location of the current road, on which road the vehicle is being driven on, from the GPS unit.

Preferably, the speed-limit-enforcing system further includes a map-memory-storage containing map data, including the maximum legal speed limit of the current road, wherein at least one of the rules, defined in the speed-limit profile of the intended driver, relates to the maximum legal speed limit of the current road. The map-memory-storage is a local device or a remote database.

Optionally, in a smart mobile devices based system, the vehicle includes a vehicular wireless communication means, having an ID, such as Bluetooth (BT). The master-smart-mobile device of the master user is adapted to obtain the ID of the vehicular wireless communication means and to transmit the ID of the vehicular wireless communication means to the remote server, to thereby record the ID of the vehicular wireless communication means in a designated location in the remote server.

When utilizing the vehicle, the personal user-mobile device of the intended driver is in communication flow with the vehicular wireless communication means and is adapted to obtain the ID of the vehicular wireless communication means. Upon identifying of the intended driver, the activation mode is turned on automatically. The personal user-mobile device of the intended driver is adapted to verify the read BT ID with the BT ID records created by the muster user. Upon verification of the ID of the corresponding BT device against the records in the remote server, a successful verification is equivalent to the activation mode being turned on.

When the activation mode is turned on, the driver-application is adapted to monitor and transmit driving parameters of the driving activity of the vehicle to the cloud server and thereby also to the master-smart-mobile device.

An aspect of the present invention is to provide a method for enforcing a speed limit, operable on a speed-limit-enforcing system disposed in a host vehicle. The method includes the steps of:

a) obtaining the current velocity of the vehicle from an external source;

b) identifying the current driver of the vehicle using the biometric driver identification device;

c) obtaining the speed-limit profile of the current driver from the drivers' profile DB;

d) determining the current speed-limit from rules defined in the speed-limit profile of the current driver;

e) comparing the current velocity of the vehicle with the current speed limit; and
i. when the current velocity of the vehicle exceeds the current speed limit, turning on the at least one warning device, and/or activating the speed-limit controller to limit the fuel supply to the engine of the vehicle, such that the velocity of the vehicle does not exceed the current speed limit.

Optionally, the method further including the step of obtaining the legal speed limit of the road on the vehicle is being driven on, wherein at least one of the rules, defined in the speed-limit profile of the current driver, relates to the maximum legal speed limit of the current road.

Optionally, the throttle controller is an accelerating-pedal-control apparatus, wherein the speed-limit controller is adapted to activate an electric motor for setting the position of a stopper, to thereby limit the depression range of the accelerator pedal, and wherein the activating of the speed-limit controller to limit the fuel supply to the engine of the vehicle. When the throttle controller is an accelerating-pedal-control apparatus, the method further includes the steps of:

a) moving the stopper by a preconfigured distance to thereby reduce the fuel supply to the engine of the vehicle;

b) obtaining again the current velocity of the vehicle;

c) comparing the current velocity of the vehicle with the current speed limit, wherein:
i. when the current velocity of the vehicle does not exceed the current speed limit, perform the step of turning off the activated warning devices and exit; else
ii. when the current velocity of the vehicle exceed the current speed limit but does not exceed the previously measured vehicle velocity, go to step (b).

When the current velocity of the vehicle exceed the current speed limit and the current velocity of the vehicle exceeds the previously measured vehicle velocity, for example if the driver exerts extra force on the pedal, perform the steps of:

a) when an override is available in the rules of the speed-limit profile of the current driver, activating the speed-limit controller to allow full range depression of the accelerator pedal, turning off the activated warning devices and exit;

b) else, when an override is not available in the rules of the speed-limit profile of the current driver, perform the step of:
i. intensifying the output of the at least one warning device; and/or
ii. activating the throttle controller to limit the fuel supplied to the engine of the vehicle by a preconfigured extent.

### BRIEF DESCRIPTION OF THE DRAWINGS

The present invention will become fully understood from the detailed description given herein below and the accompanying drawings, which are given by way of illustration and example only and thus not limitative of the present invention, and wherein:

FIG. 1 (prior art) is a perspective view of an accelerating-pedal-control apparatus, according to embodiments of the present invention, mounted on the cabin floor of a vehicle and supported by the wall of the engine compartment, wherein the accelerating pedal is free to move down in the full height of the depression range, and wherein the accelerating pedal is in a non-depressed state.

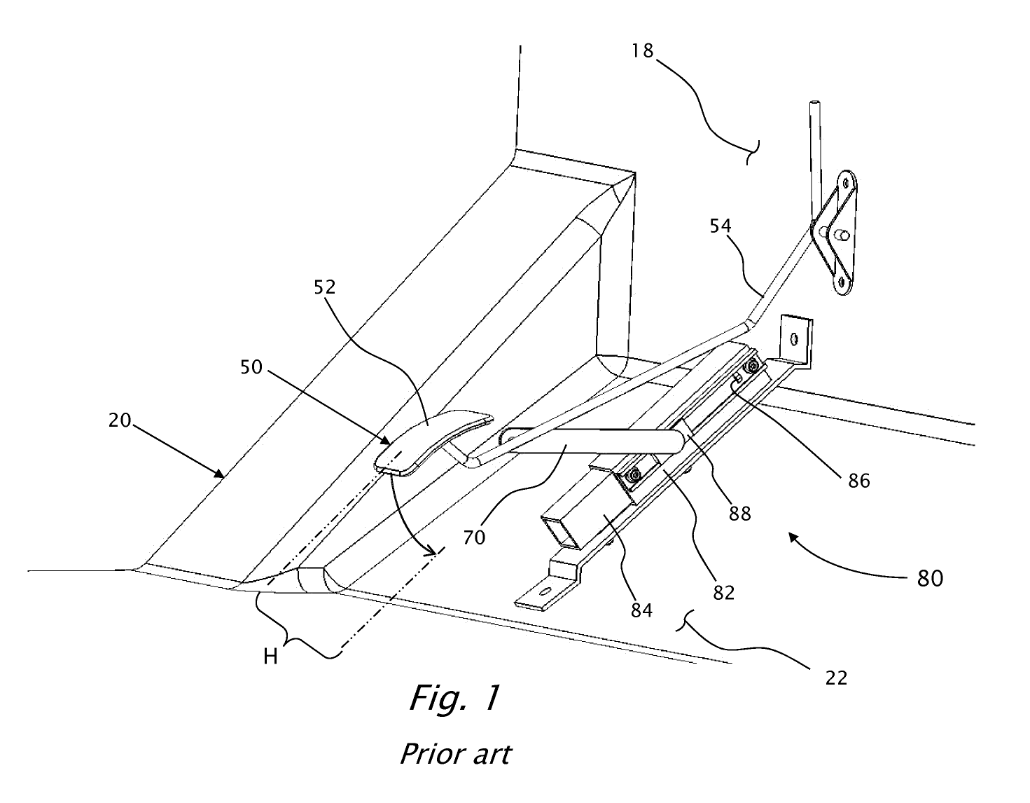

FIG. 2 (prior art) is a perspective view of the accelerating-pedal-control apparatus shown in FIG. 1, wherein the accelerating pedal is in a fully-depressed state.

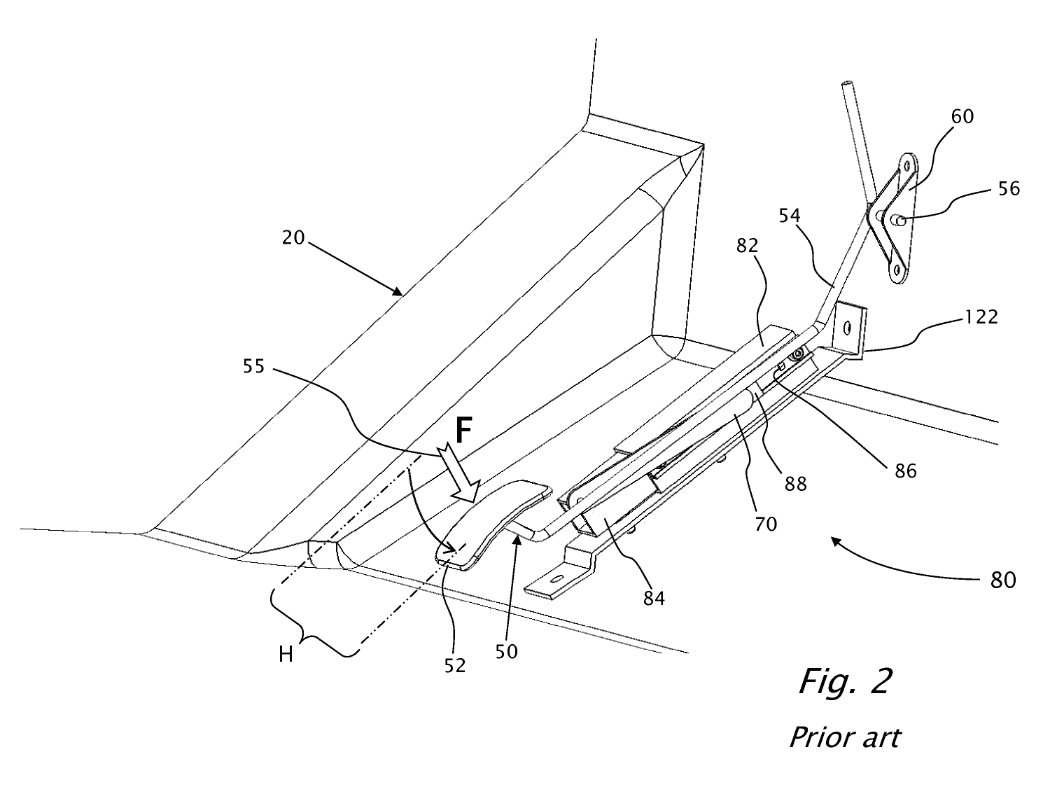

FIG. 3 (prior art) is a perspective view of the accelerating-pedal-control apparatus shown in FIG. 1, wherein the accelerating pedal is limited in moving down by an intermediate height of the depression range, and wherein the accelerating pedal is in a non-depressed state.

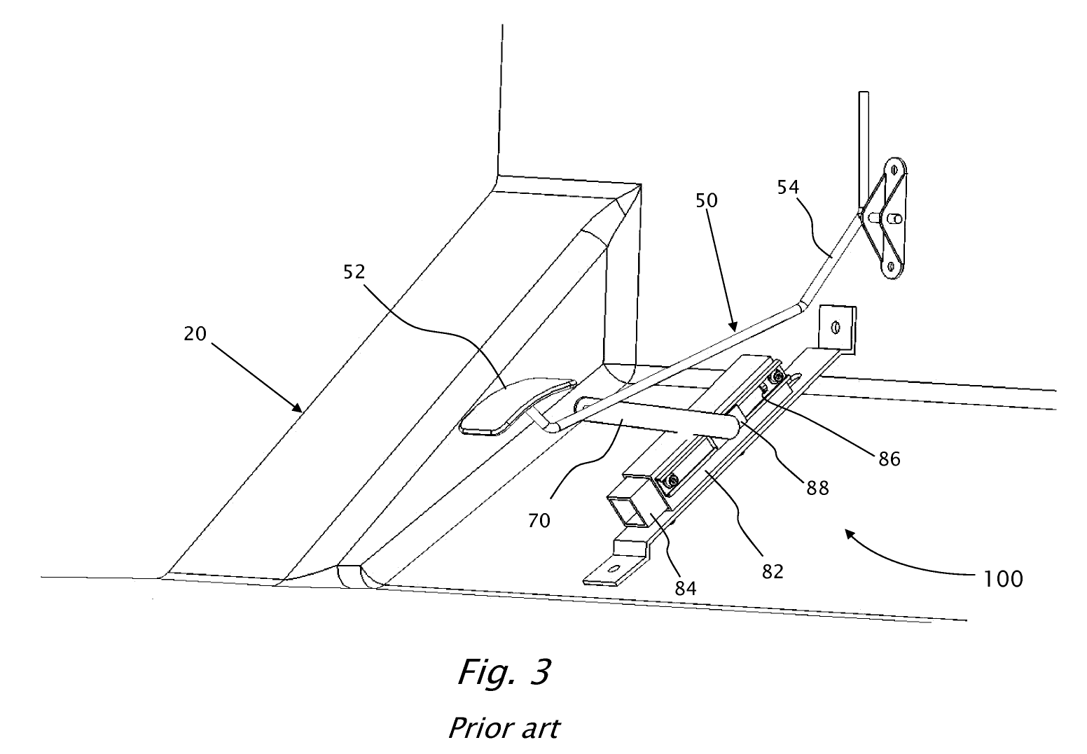

FIG. 4 (prior art) is a perspective view of the accelerating-pedal-control apparatus shown in FIG. 10, wherein the accelerating pedal is in a fully-depressed state and wherein the sliding element is blocked by the stopper to thereby prevent the accelerating pedal from being further depressed.

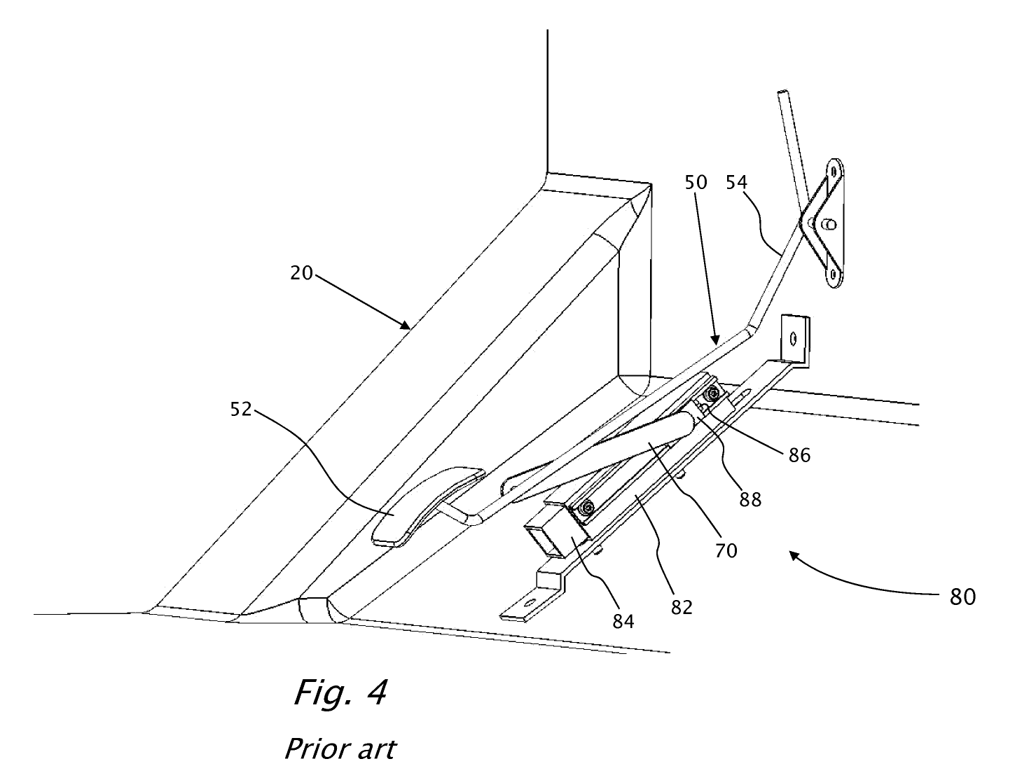

FIG. 5 (prior art) is a perspective view of the accelerating-pedal-control apparatus shown in FIG. 1, wherein the accelerating pedal is fully limited in moving down.

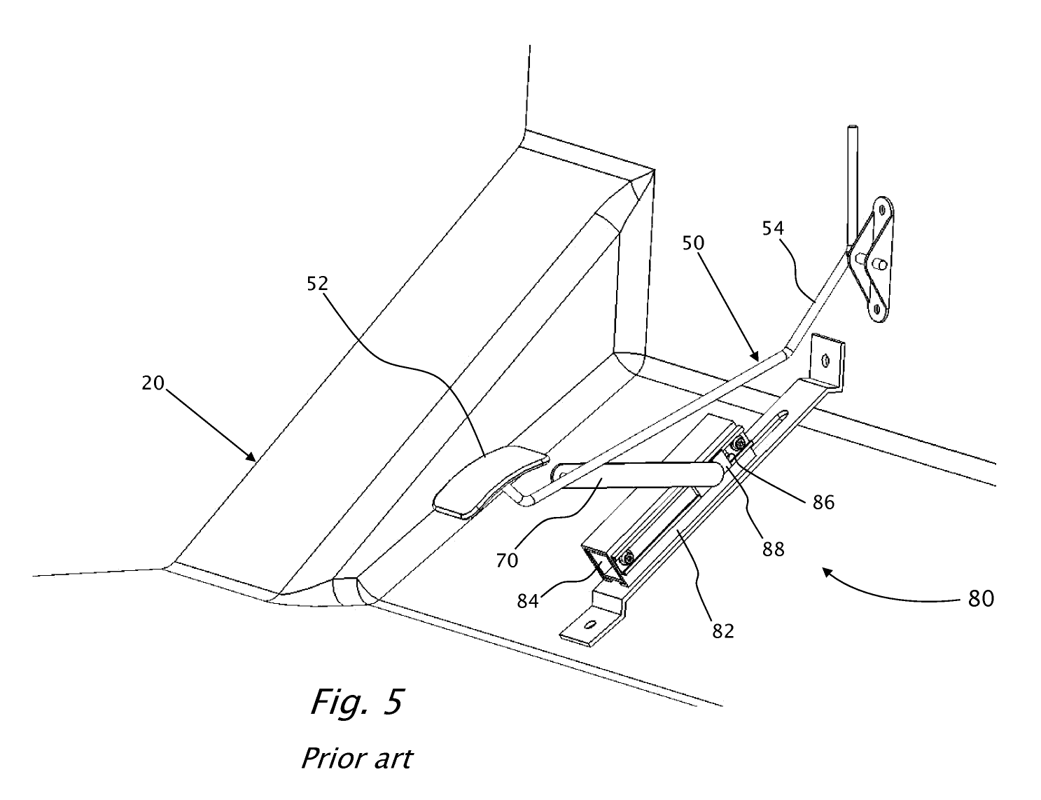

FIG. 6 is a schematic block diagram showing an exemplary system for enforcing the local road speed limit on the host vehicle, according to embodiments of the present invention.

FIG. 7 is a schematic flow chart showing an exemplary basic method of enforcing the local road speed limit on the host vehicle, according to embodiments of the present invention.

FIG. 8 is a schematic flow chart showing an exemplary elaborated method of enforcing the local road speed limit on the host vehicle, according to embodiments of the present invention.

FIG. 9 is a schematic flow chart showing an exemplary method of activating speed limit enforcing system shown in FIG. 6.

FIG. 10 is a schematic flow chart showing an exemplary method of administrating the speed limit profiles of drivers, according to embodiments of the present invention.

FIG. 11 is a schematic flow chart showing an exemplary method of controlled throttle operation and providing antitheft means, according to embodiments of the present invention.

FIG. 12 is a schematic block diagram showing an exemplary system for enforcing the local road speed limit on the host vehicle, according to embodiments of the present invention.

FIG. 13 is a schematic flow chart showing an exemplary basic method of enforcing the local road speed limit on the host vehicle, according to embodiments of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided, so that this disclosure will be thorough and complete, and will fully convey the scope of the invention to those skilled in the art.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

Meanings of technical and scientific terms used herein are to be commonly understood as to which the invention belongs, unless otherwise defined. The present invention can be implemented in the testing or practice with methods and materials equivalent or similar to those described herein.

It should be noted that orientation related descriptions such as “bottom”, “up”, “upper”, “down”, “lower”, “top” and the like, assumes that the associated item is operationally situated.

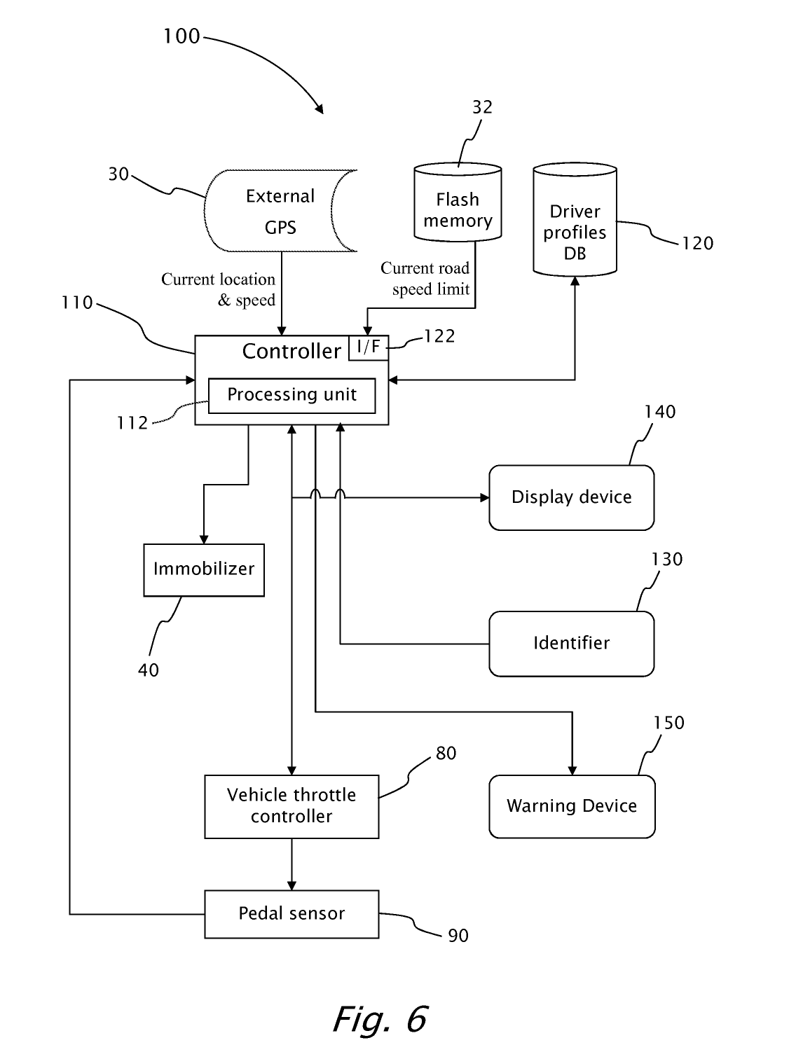

Reference is made back to the drawings. FIG. 6 is a schematic block diagram showing an exemplary system 100 for enforcing the local road speed limit on the host vehicle, subject to rules as defined in the speed-limit profile of the current driver of the vehicle, according to embodiments of the present invention. The rules in the speed-limit profile of each driver of the vehicle are predefined by the car owner of the vehicle or any other authorized person (referred to herein as the “car owner”), and kept in a drivers' profile DB 120 that is in operational communication with speed-limit-enforcing system 100.

Speed-limit-enforcing system 100 further includes a speed-limit controller 110 having a processing unit 112, an optional flash memory interface slot 122 for operatively accommodating an external memory 32, a biometric-driver-recognition device 130, such as a fingerprint reader, a display 140 and one or more warning devices 150.

Optionally, speed-limit-enforcing system 100 is in operational communication flow with a throttle controller, such as, with no limitation, accelerating-pedal-control apparatus 80 (referred to herein as “throttle controller” 80), with an external GPS unit 30 and/or with the vehicle's immobilizer 40. The present invention will be described in terms of the throttle controller being accelerating-pedal-control apparatus 80, with no limitation on using any other throttle controllers known in the art including the throttle controller mentioned in the background.

Processing unit 112 enables a car master user, typically an owner of the car or any other person authorized by the car owner, to define a speed-limit profile for each particular driver, and store the speed-limit profiles in drivers' profile DB 120.

Processing unit 112 is configured to read GPS data from GPS unit 30, including the vehicle velocity and the geographical location of the current road on which the vehicle is driving on. Processing unit 112 is configured to read the allowed speed limit, associated with the current road, from a memory storage containing geographical maps, including streets and roads and maximum legal speed limit, associated with each street/road (herein after referred to as “map data”). The memory containing the map data may be, with no limitation, a SDHC card or any other flash memory card 32,

Thereby, processing unit 112 can determine whether the driver has caused the vehicle to exceed the speed limit as set for the road on which the vehicle is situated. The processing unit 112 may further determine, by reading the speed-limit rules set for that specific driver in the speed-limit profile of that driver, if passive or active enforcement is to be applied, and when to activate that enforcement. If so set in the speed-limit profile of that driver, processing unit 112 activates throttle controller 80 to controllably force the vehicle to reduce the speed of the vehicle, to comply with the current road speed limit and/or with the rules set in speed-limit profile of that driver.

Optionally, display 140 is a touch screen, enabling entering input to processing unit 112, in particular when setting up the profiles of drivers. Optionally, display 140 is a detachable device, wherein speed-limit-enforcing system 100 is adapted to operate when display 140 is detached.

Optionally, driver-identifier 130 is a fingerprint reader. However, the present invention may include other biometric-driver-recognition devices known in the art such as face recognition, iris recognition and the like, or any other uniquely identifying devices known in the art. The present invention will be described in terms of using a fingerprint reader, with no limitation on using any other identifying device known in the art.

Speed-limit controller 110 of speed limit-enforcing system 100 may further control an electric motor for setting the position of a stopper 86, thereby limiting the depression range of the accelerator pedal 52.

The dimensions of speed limit-enforcing system 100 can be adapted to each car model, for enabling the installation of speed limit-enforcing system 100 in the car.

Speed limit-enforcing system 100, for limiting the vehicle speed, can also be used as part of a car antitheft system. When the car ignition key is turned off, stopper 86 may be set such that accelerating pedal 52 is raised to the upper most state. This may prevent stealing the car, since a thief cannot press the accelerator pedal to drive the car away. Thus, the invention can prevent a car from being stolen, when speed limit-enforcing system 100 is activated to prevent car theft, such that accelerator pedal 52 cannot be activated by unauthorized persons.

Speed limit-enforcing system 100 can be used as an add-on to any vehicle. There is no change required in the vehicle itself. Speed limit-enforcing system 100 of the present invention includes means for adapting speed-limit-enforcing system 100 to the topography of the inner surface of the cabin of the hosing vehicle.

Speed limit-enforcing system 100 provides the car owner with full flexibility in setting the speed limit for him/her and/or allowed drivers, for all types of roads/streets.

If there is no GPS signal (for example: tunnels or malfunction) the system will allow the throttle (acceleration pedal) to be open up only to a predetermined level, for example, up to 50% of the available maximum range. If there is no location information available (for example: the road is not on a GPS map or the vehicle is off-road), the speed limit may be set to the maximum intercity limit in the country (110 km/h in Israel).

It should be noted that speed limit-enforcing system 100 may also provide the comfort of driving at a steady speed without worrying about over speeding, both on highway and on city streets.

Another aspect of the present invention is to enable entering personal profiles for each driver of a particular car. The system identifies the driver, preferably via biometric data, wherein speed-limit rules are tailored to each driver.

Speed limit-enforcing system 100 may record and analyze statistical data of the driving behavior of each driver of the vehicle. The data may be collected in a database, internal memory or external memory.

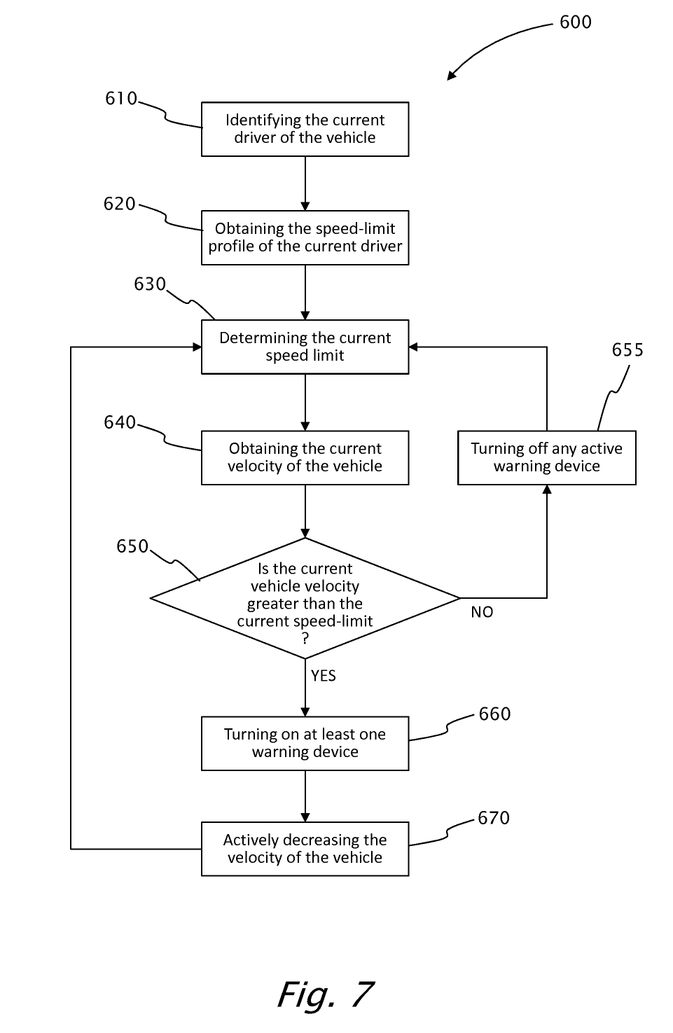

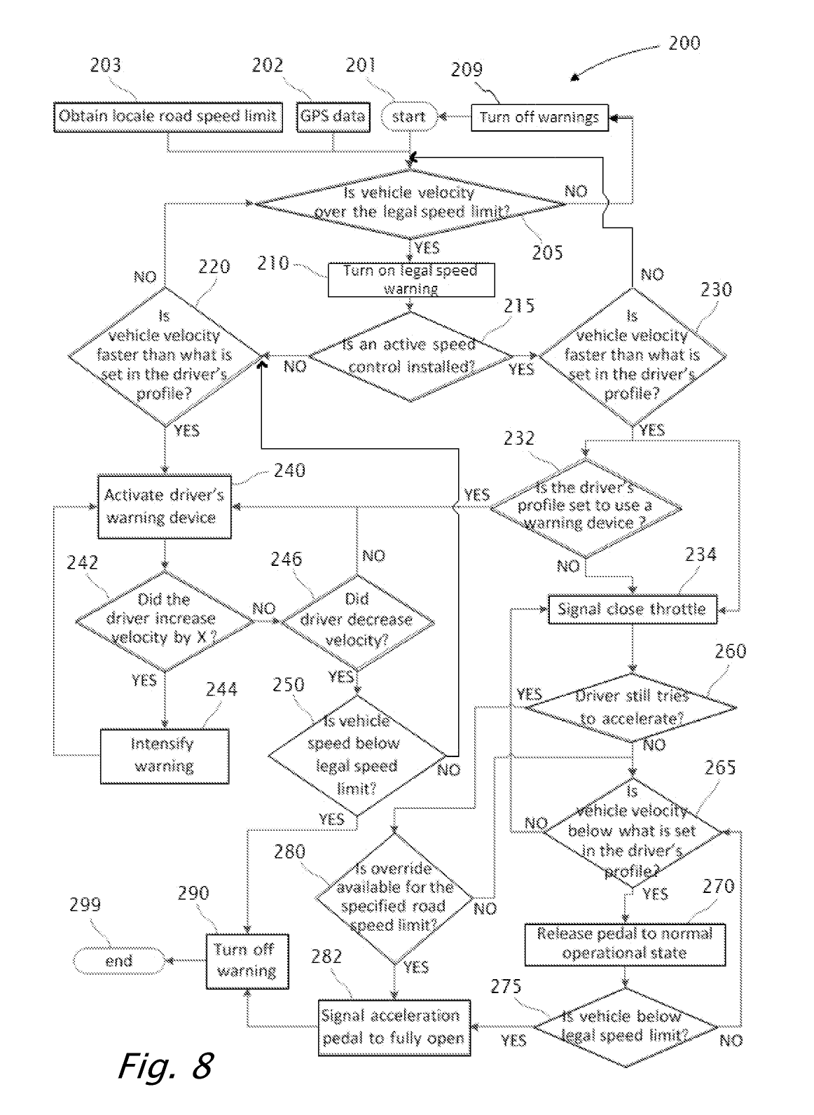

It is an aspect of the present invention to provide methods for enforcing the local road speed limit on the host vehicle, as outlined in FIGS. 7 and 8. The methodology for enforcing a speed limit on a host vehicle, according to embodiments of the present invention, is based on predefined, personal speed-limit profiles of allowed drivers of the vehicle. Basic speed-limit-enforcing method 600 and elaborated speed-limit-enforcing method 200, for enforcing a speed limit on the host vehicle, based on the speed-limit profile of the current driver of the vehicle, is typically performed by a speed-limit-enforcing system 100 for limiting the maximum speed of a vehicle, by controlling the rate at which gas is supplied to the engine of the vehicle. In one embodiment, the rate at which gas is supplied to the engine of the vehicle uses an accelerating pedal limiting apparatus 80 for controlling the available depression range of the accelerating pedal 52 in a vehicle.

Basic speed-limit-enforcing method 600 outlines the principle methodology of enforcing the local road speed limit on the host vehicle. Method 600 includes with the following steps:

Step 610: identifying the current driver of the vehicle.

Processing unit 112 identifies the current driver of the vehicle using a driver-identifier 130, for example, using a fingerprint reader, a face recognition device, an iris reader and/or any other identifying device known in the art.

Step 620: obtaining the speed-limit profile of the current driver.

Processing unit 112 fetches the profile of the current driver from drivers' profile DB 120 including rules for defining the current speed-limit.

Step 630: determining the current speed limit.

Processing unit 112 computes the current speed-limit for the current driver of the vehicle. The computation is based on the rules for defining the current speed-limit, as set for the current driver. The parameters for the computation may further include the legal speed-limit of the current road on which the vehicle is driving on. The geographical location of the vehicle is obtained from a GPS and the legal speed-limit of the current road is obtained from geographical maps having legal speed-limit data, residing in an external data source, such as, with no limitation, a SDHC card or any other flash memory card 32 or a remote source.

Step 640: obtaining the current velocity of the vehicle.

Processing unit 112 obtains the current velocity of the vehicle, using for example, GPS data from GPS 30 or from the computer of the vehicle (for example, by connecting to the CAN bus) and/or from any other available source.

Step 650: checking if the current vehicle velocity is greater than the current speed-limit.

Processing unit 112 checks if the current vehicle velocity is greater than the determined current speed-limit.

If the velocity of the vehicle is not faster than the speed limit as set in the profile of the current driver, turning off any active warning device (step 655) and go to step 630.

Step 660: turning on at least one warning device.

Processing unit 112 turns on one or more warning devices 150.

Step 670: actively decreasing the velocity of the vehicle.

Processing unit 112 activates throttle controller 80 to close the gas throttle by a preconfigured extent.

Go to step 630.

[end of method 600]

Preferably, elaborated speed-limit-enforcing method 200 uses GPS data, supplied in step 202 by GPS 30 and local road speed limit data, obtained in step 203. Method 200 starts (step 201) by also obtaining the current speed of the vehicle from the GPS data, the computer of the vehicle (for example, by connecting to the CAN bus) and/or from any other available source. Method 200 proceeds with the following steps:

Step 205: checking if the current vehicle velocity is over the legal speed limit.

Processing unit 112 compares the current vehicle speed to the local road speed limit, if available. If the local road speed limit is not available, the vehicle current speed is compared to the maximum urban speed allowed, if urban/country data location is known, or otherwise, to another default value, such as the maximum speed limit allowed in the country.

If the current vehicle speed is not over the allowed speed limit, go to step 209.

Step 209: turn off warnings.

If one or more warnings were previously activated, processing unit 112 turns off warnings that were previously activated.

Go to step 201.

Step 210: turn on warning.

Since the current vehicle speed limit is over the legal speed limit, processing unit 112 turns on warning one or more warning indicators, indicating to the driver that the vehicle speed is over the allowed speed limit.

Step 215: checking if an active speed control unit is installed in the vehicle.

Processing unit 112 checks if a system 80, for limiting the maximum speed of a vehicle, is installed in the vehicle.

If a system 100, for limiting the maximum speed of the vehicle, is installed in the vehicle, go to step 230.

Step 220: checking if the vehicle velocity is faster than what is set in the profile of the current driver.

Processing unit 112 fetches the profile of the current driver from drivers' profile DB 120 and checks if the velocity of the vehicle is faster than what is set in the profile of the current driver.

If the velocity of the vehicle is not faster than what is set in the profile of the current driver, go to step 205.

Else, go to step 240.

Step 230: checking if the vehicle velocity is faster than what is set in the profile of the current driver.

Processing unit 112 fetches the profile of the current driver from drivers' profile DB 120 and checks if the velocity of the vehicle is faster than what is set in the profile of the current driver.

If the velocity of the vehicle is not faster than what is set in the profile of the current driver, go to step 205.

Step 232: checking if the profile of the current driver is set to use a warning device.

Processing unit 112 checks if the profile of the current driver is set to use a warning device.

If the profile of the current driver is set to use a warning device, go to step 240.

Step 234: signal close throttle.

Processing unit 112 activates throttle controller 80 to close the gas throttle by a preconfigured extent.

Go to step 260.

Step 240: activating the driver's warning device.

Processing unit 112 activates the driver's one or more warning devices.

Step 242: checking if the driver has increased velocity of the vehicle by a more than a threshold value X.

Processing unit 112 checks if the driver has increased the velocity of the vehicle by a more than a threshold value X.

If the driver has not increased the velocity of the vehicle by a more than a threshold value X, go to step 246.

Step 244: intensify warning.

Processing unit 112 intensifies the warning, for example by amplifying the audio warning, increasing the warning frequency and/or change the audio sound to have a higher pitch.

Go to step 240.

Step 246: checking if the driver has decreased velocity of the vehicle.

Processing unit 112 checks if the driver has decreased the velocity of the vehicle.

If the driver has not decreased the velocity of the vehicle, go to step 240.

Step 250: checking if the vehicle velocity is below the legal speed limit.

Processing unit 112 checks if the vehicle velocity is below the legal speed limit.

If the vehicle speed limit is over the allowed speed limit, go to step 220;

else, go to step 290.

Step 260: checking if the driver still tries to accelerate.

Processing unit 112 checks if the driver still tries to accelerate the vehicle velocity.

If the driver still tries to accelerate the vehicle velocity, go to step 280;

Step 265: checking if the vehicle velocity is below what is set in the driver's profile.

Processing unit 112 checks if the vehicle velocity is below what is set in the driver's profile.

If the vehicle speed limit is over what is set in the driver's profile, go to step 234;

Step 270: release pedal to normal operational state.

Processing unit 112 releases pedal 52 to a normal operational state, which state is not limited by the acceleration-pedal-depression system.

Go to step 240.

Step 275: checking if the vehicle velocity is below the legal speed limit.

Optionally, processing unit 112 checks if the vehicle velocity is below the legal speed limit.

If the vehicle speed limit is over the allowed speed limit, go to step 265; else, go to step 282.

Step 280: checking if an override is available for the current road speed limit.

Processing unit 112 checks in the speed-limit profile of the current driver, if an override is available for the speed-limit of the type of road associated with current road.

If an override is not available for the current road speed limit, go to step 265.

Step 282: signal acceleration pedal to fully open.

Processing unit 112 activates the controller of acceleration pedal to allow a full range operation of pedal 52.

Step 290: turn off warning.

Processing unit 112 deactivates the previously activated one or more warning devices.

Exit (step 299).

[end of method 200]

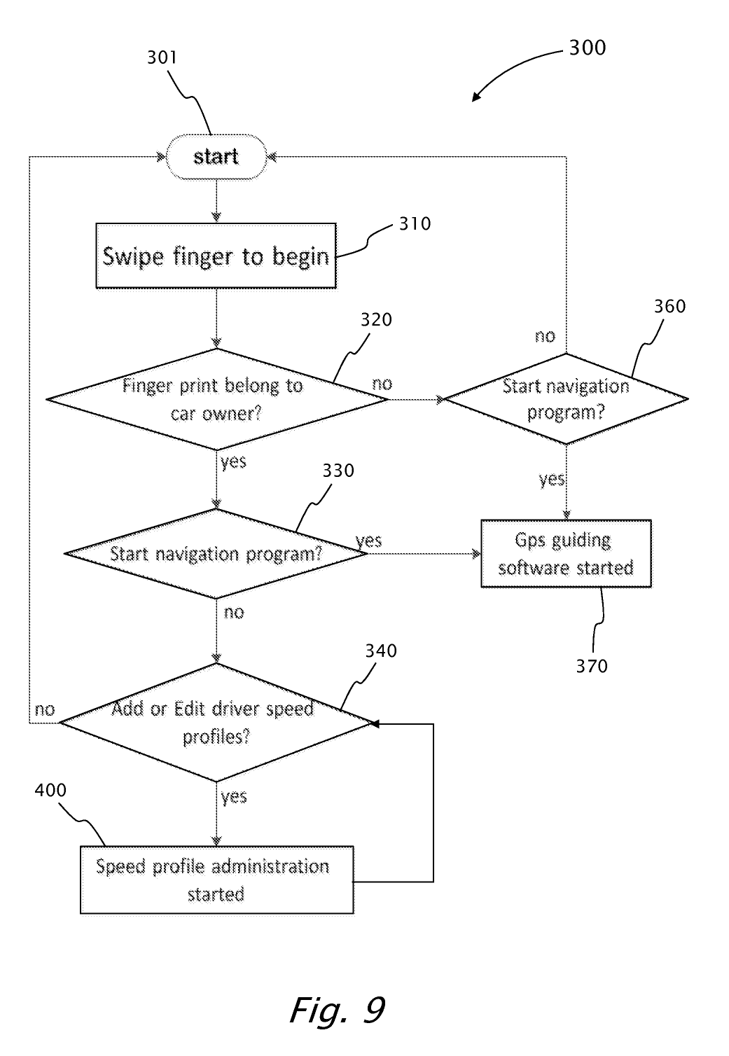

As outlined in FIG. 9, an aspect of the present invention is to provide an example method 300 for activating speed-limit-enforcing system 100 in a vehicle, according to embodiments of the present invention. Method 300 starts in step 301. Method 300 proceeds with the following steps:

Step 310: swipe finger.

The driver swipes his/her finger next to the scanning window of driver-identifier 130, wherein processing unit 112 reads the fingerprint of that fingertip.

Step 320: checking if the read fingerprint belongs to the owner of the vehicle.

Processing unit 112 checks if the read fingerprint belongs to the owner of the vehicle.

If the read fingerprint does not belong to the owner of the vehicle, go to step 360.

Step 330: checking if wants to start the navigation program.

Processing unit 112 checks if wants to start the navigation program.

If the driver desires to start the navigation program for a normal drive, go to step 370.

Step 340: checking if want to add or edit the profile of a driver.

If the owner does not desire to start the navigation program, at least not yet, processing unit 112 checks if he/she wants to add or edit the profile of a driver.

If it is not desired to add or edit the profile of a driver, go to step 301.

Step 400: perform profile administration of allowed drivers, including the speed profile of the respective driver.

An interactive process of administrating the profile of the current driver, including the speed profile of the current driver, is performed.

Go to step 340.

Step 360: checking if the person wants to start the navigation program.

Processing unit 112 checks if the person wants to start the navigation program.

If the driver does not desire to start the navigation program for a normal drive, go to step 301.

Step 370: activate the GPS navigation process.

Processing unit 112 activates the GPS navigation process, including the operation of the acceleration-pedal-depression system.

[end of method 300]

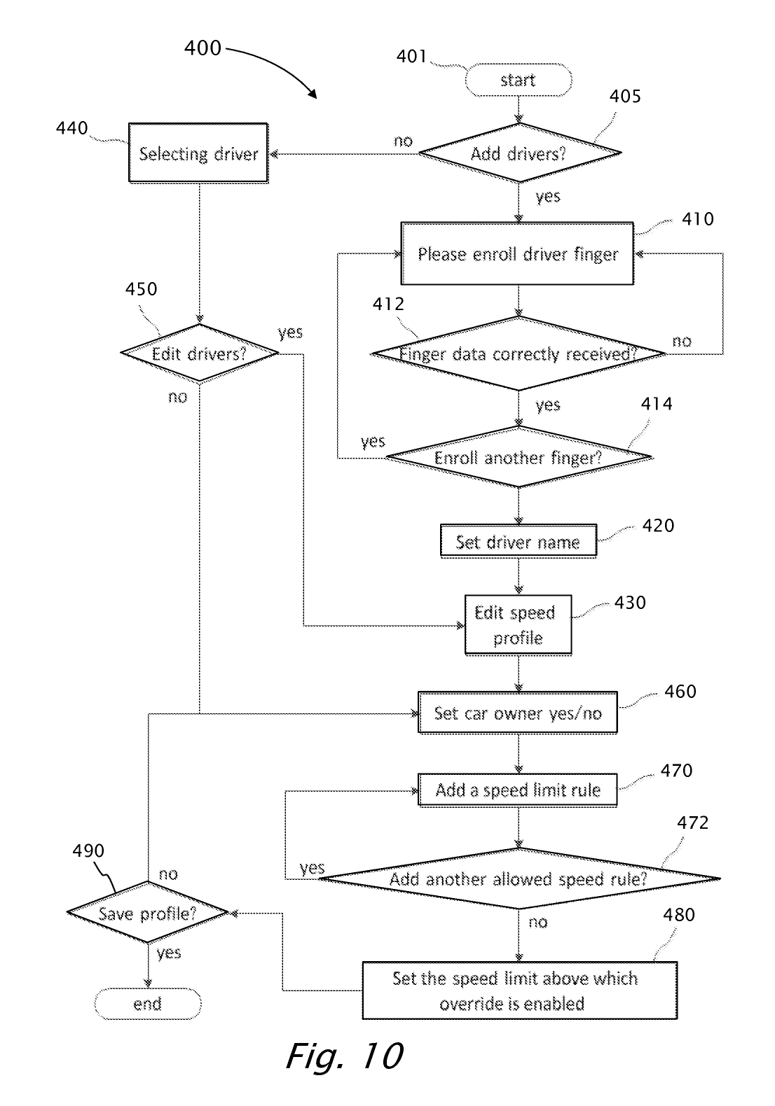

As outlined in FIG. 10, an aspect of the present invention is to provide an example method 400 for administrating the speed limit profiles of drivers of a vehicle, according to embodiments of the present invention. Method 400 starts in step 401. Method 400 proceeds with the following steps:

Step 405: checking if want to add a speed limit profile for a new driver.

Processing unit 112 checks if the owner of the vehicle wants to add a speed limit profile for a new driver.

If the owner of the vehicle does not want to add a speed limit profile for a new driver, go to step 440.

Step 410: swiping finger by the new driver.

The new driver swipes his/her finger next to the scanning window of driver-identifier 130, wherein processing unit 112 reads the fingerprint of that fingertip.

Step 412: checking if the read fingerprint data is acceptable.

Processing unit 112 checks if the read fingerprint data is acceptable.

If the read fingerprint data is not acceptable, go to step 410.

Step 414: checking if the new driver wants to enroll the fingerprint another finger.

Processing unit 112 checks if the new driver wants to enroll the fingerprint of another finger.

If the new driver wants to enroll the fingerprint another finger, go to step 410.

Step 420: set drivers ID name.

Entering personal data, including identification name, which identification data is stored in the drivers' profile DB 120.

Step 430: edit the speed-limit profile of the new driver.

Entering speed limit related data, and possibly other parameters, into the speed-limit profile of the new driver, typically by the car owner, which speed limit data is stored in the drivers' profile DB 120. The other parameters may include data such as, whether throttle controller 80 is to be activated, the type and/or sequence of warning, if and the type of roads on which override is allowed, etc.

Go to step 460.

Step 440: selecting a driver.

Since the owner of the vehicle, or any other authorized person (herein referred to as “the owner”), does not want to add a speed limit profile for a new driver, processing unit 112 prompt the owner of the vehicle to select an existing driver.

Step 450: checking if want to edit the speed limit profile of the selected driver.

Processing unit 112 checks if the owner of the vehicle wants to edit the speed limit profile of the selected driver.

If the owner of the vehicle wants to edit the speed limit profile of the selected driver, go to step 430.

Step 460: identifying the driver as an owner or not.

The new driver, or the selected driver, is defined as either having a car owner authority or not.

Step 470: add a speed limit rule.

The car owner adds a new speed-limit rule in the profile of the new driver, or the selected driver.

A speed limit rule instructs processing unit 112 how to act, for the specific driver, if particular events occur. For example:
1. When driving on a road having speed limit of A mph, activate the audio alert when reaching B mph and actively slow down the car when reaching C mph.
2. Enable override when driving on a road having legal speed limit of D mph.
   Step 472: checking if need to add a new speed-limit rule.

Processing unit 112 checks if the owner wants to add a new speed-limit rule or edit an existing speed-limit rule.

If the owner wants to add a new speed-limit rule, go to step 470.

Step 480: set the speed limit above which override is enabled.

The car owner sets, in the profile of the new driver or the selected driver, the speed limit, above which speed override is enabled.

Step 490: checking if wants to save the speed-limit profile, and exit.

Processing unit 112 checks if the owner wants to wants to save the speed-limit profile, and exit.

If the owner does not want to save the speed-limit profile, go to step 460;

Else, if the owner wants to save the speed-limit profile, and exit, the new/edited speed-limit profile is saved in the drivers' profile DB 120, and the administration process is terminated.

[end of method 400]

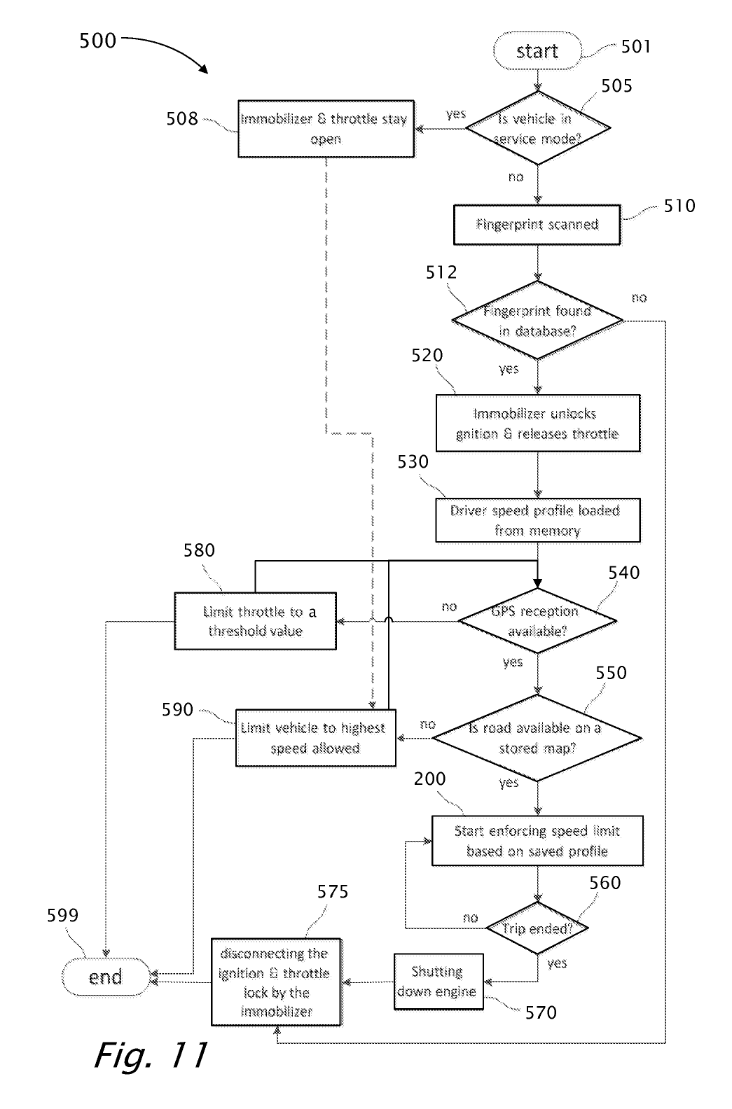

As outlined in FIG. 11, an aspect of the present invention is to provide an example controlled throttle operation and antitheft method 500, according to embodiments of the present invention. Method 500 starts in step 501. Method 500 proceeds with the following steps:

Step 505: checking if the vehicle is in service mode.

Processing unit 112 checks if the vehicle is in operation mode.

If the vehicle is not in service mode, go to step 510.

Step 508: immobilizer and throttle stay open.

Processing unit 112 keeps the immobilizer 40 and throttle stay open to enable normal operation of the vehicle.

Go to step 590.

Step 510: swiping finger by the driver.

The vehicle is not in operation mode, as yet. The new or selected driver swipes his/her finger next to the scanning window of driver-identifier 130, wherein processing unit 112 reads the fingerprint of that fingertip.

Step 512: validating the read fingerprint.

To validate the read fingerprint, processing unit 112 checks if the read fingerprint data is in the drivers' profile DB 120.

If the read fingerprint data was not found in drivers' profile DB 120, go to step 575.

Step 520: unlocking the immobilizer and ignition & releasing the throttle.

Processing unit 112 unlocks immobilizer 40 and ignition, and releases the throttle.

Step 530: uploading the speed-limit profile of the identified driver, from memory.

Processing unit 112 uploading the speed-limit profile of the identified driver, from the drivers' profile DB 120.

Step 540: checking if GPS data is available.

Processing unit 112 checks if GPS data is available from GPS 30.

If no GPS data is available, go to step 580.

Step 550: checking if speed limit data of the road is available.

Processing unit 112 checks if speed limit data of the road, on which the vehicle is currently situated on, is available from a respective stored map.

If no speed limit data of the road on which the vehicle is currently situated on is available, go to step 590.

Step 200: start enforcing the speed limit as set in the driver's profile and external data available.

Processing unit 112 performs speed-limit-enforcing method 200 for enforcing the local road speed limit on the vehicle, as set in the driver's profile and using GPS data, as supplied by GPS 30, and using local road speed limit data.

Step 560: checking if the trip has ended.

Processing unit 112 checks if the trip of the vehicle has ended.

If the trip of the vehicle has not ended, go to step 200.

Step 570: shutting down engine.

The driver shuts down engine.

Step 575: disconnecting the ignition & throttle lock by the immobilizer.

The vehicle disconnects the ignition & throttle lock by the immobilizer.

Optionally, the acceleration-pedal-depression system, such as acceleration-pedal-depression system 80, locks the acceleration pedal 52 in the upper most position.

Exit (step 599).

Step 580: limit the vehicle throttle to a preconfigured threshold value.

Processing unit 112 limits the vehicle throttle to e preconfigured threshold value.

Go to step 540.

Step 590: limit vehicle to highest speed allowed.

Processing unit 112 limits vehicle velocity to highest speed allowed. For example, the speed limit may be set to the maximum intercity speed limit allowed in the country (110 Km/h in Israel). If it is known that the vehicle is situated in an urban location, that the speed limit may be set to the maximum urban speed limit allowed in the country (70 Km/h in Israel)

Go to step 540.

[end of method 500]

Speed limit-enforcing system 100 can be used as an add-on to any vehicle. There is no change required in the vehicle itself.

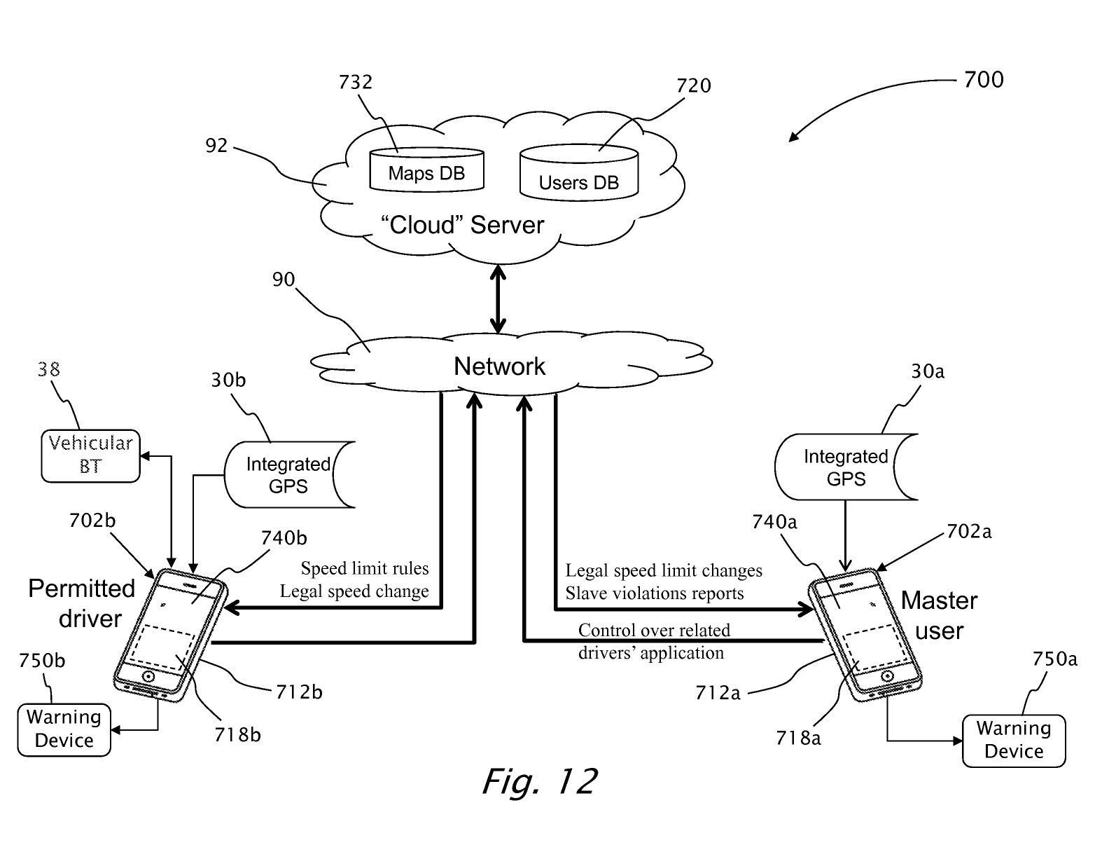

According to teachings of another embodiment variation, the drivers' profile database and the maps DB are disposed on a remote server. FIG. 12 is a schematic block diagram showing an example system 700 for enforcing the local road speed limit on the host vehicle, subject to rules as defined in the speed-limit profile of the current driver of the vehicle. The rules in the speed-limit profile of each driver of the vehicle are predefined by the car owner of the vehicle or any other authorized person (referred to herein as the “car owner”), and kept in a drivers' profile DB 720 that is disposed on a remote server, such as cloud server 92. Cloud server 92 further includes the maps data, including roads legal speed limits, in maps DB 732. Cloud server 92 is in operational communication with a master-smart-mobile device 702a and with at least one user-smart-mobile device 702b of a respective supervised driver. The smart-mobile devices (702a and 702b) are preferably, with no limitations, smart phones, but can also be any PDA, configured to communicate with the remote server.

Each smart-mobile device (702a and 702b) includes a processing unit 712, an integrated GPS 30, an application 718, executed by processing unit 712, a display 740 and one or more warning devices 750. It should be noted that the drivers' profiles and the master profile, includes the respective identification data of each respective smart-mobile device (702a and 702b).

Master-application 718a, running on master-smart-mobile device 702a, facilitates a master user to enable the activation/deactivation a selected driver-application 718b, running on the respective user-smart-mobile device 702b. Preferably, master-application 718a is a downloadable smart-phone application. Preferably, driver-application 718b is a downloadable smart-phone application.

Each smart-mobile device (702a and 702b) includes a processor and at least one computer-readable medium having computer-executable instructions stored thereon that, when executed, cause the processor to perform at least one task by at least one component of the respective smart-mobile device. The respective application (master-application 718a or driver-application 718b) embody the computer-executable instructions that is stored in the computer-readable medium.

Once a driver-application 718b is activated, processing unit 712b, being in communication flow with as cloud server 92, begins transmitting GPS location data to thereby continuously update DB 720, in preconfigured time intervals, with the driver's location data and optionally, the derived travelling speed. Preferably, cloud server 92, begins transmitting the speed limit of the current road, obtained from maps DB 732.

Optionally, once a driver-application 718b is activated, cloud server 92, being in communication flow with processing unit 712a of master-smart-mobile device 702a, the location data of the respective driver, from DB 720, in preconfigured time intervals, with the driver's location data and optionally, the derived travelling speed. Alternatively, if the derived travelling speed is not transmitted, processing unit 712a calculates the travelling speed of the respective driver. Furthermore, cloud server 92 transmits the speed limit of the current road, on which road the selected driver is moving on, obtained from maps DB 732. If the velocity of the selected driver is calculated to be faster than what is set in the profile of the current driver, processing unit 712 turns on one or more warning devices 750.

Optionally, a speed violation history of the selected driver is kept in DB 720, and is optionally transmitted to processing unit 712a of master-smart-mobile device 702a. Alternatively, a speed violation history of the selected driver is kept in the memory of master-smart-mobile device 702a.

Optionally, drivers' activation data is kept and updated in DB 720. It should be noted that only a master user has update privileges in DB 720, including the drivers' activation data.

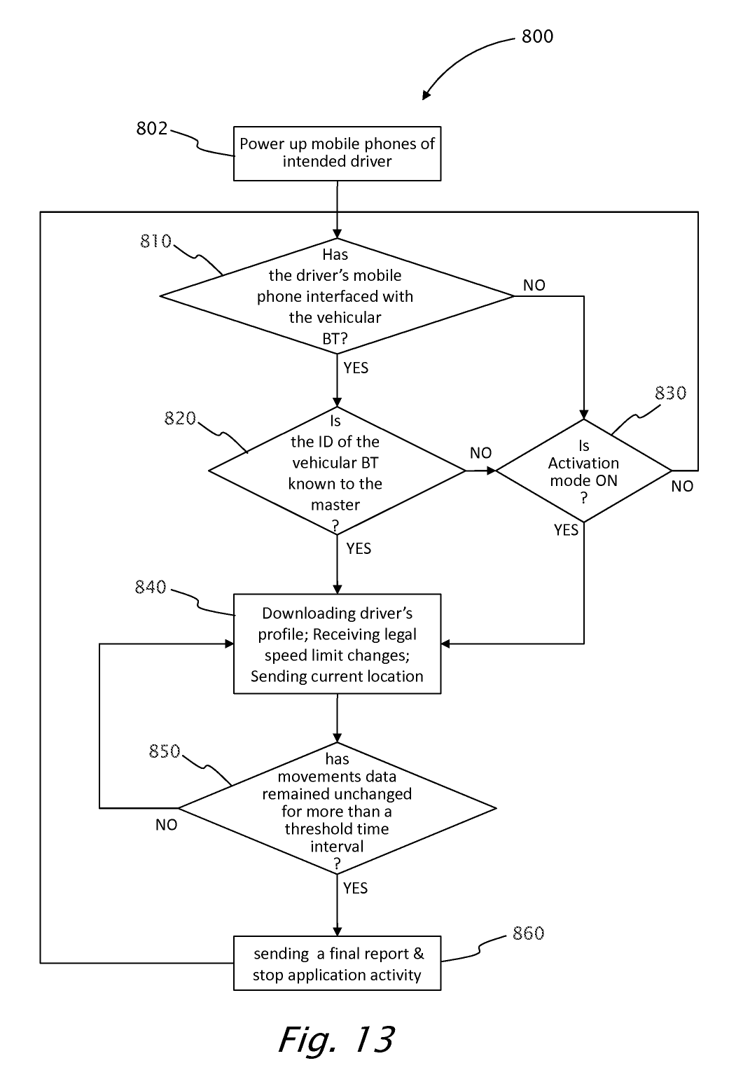

Reference is also made to FIG. 13, a schematic flow chart showing an exemplary basic method 800 of enforcing the local road speed limit on a supervised driver, according to embodiments of the present invention. In step 802 the intended driver powers up his/her smart-mobile device 702b or 702a, to thereby activate his/her driver-application 718b or master-application 718a, respectively. It should be noted that to enable the master user to monitor the driving of the intended driver, his/her master-application 718a must be activated as well.

It should be noted that at the first time, when the intended driver installs the driver-application 718b, the driver-application 718b is linked to the respective master-application 718a, and the driving rules are loaded from the respective profile, as set by the master user and stored in DB 720. Preferably, in all successive operations of the driver's personal user-smart-mobile device 702b, the driver-application 718b is automatically activates at the power up boot of his/her personal user-smart-mobile device 702b.

Preferably, speed limit-enforcing method 800 proceeds with the personal user-smart-mobile device 702b of the intended driver, interfacing with the vehicular BT 38 (see FIG. 12), assuming that the vehicular BT 38 exists and is activated. Upon interfacing the vehicular BT 38, driver-application 718b reads and sends the vehicular BT ID to cloud server 92.

If user-smart-mobile device 702b has interfaced with the vehicular BT 38, and if the ID of the vehicular BT has been identified by the master-application 718a, then speed limit-enforcing method 800 proceeds with monitoring the driving activity of the vehicle, as described here below (step 840). Optionally, the master user may create a record containing known vehicles and the ID of the corresponding BT device, to thereby facilitate the identification of the vehicle and the intended driver. Upon identifying of the intended driver, the activation mode is turned on automatically.

Else, if the master user has activated (step 830) the driver-application 718b, running on the personal user-smart-mobile device 702b of that driver, the monitoring process begins (step 840). Else, return to step 810.

It should be noted that since the vehicular BT 38 is intended for use of the driver (rather that the passengers), it is assumed that the personal user-smart-mobile device 702b, being in communication flow with vehicular BT 38, is the smart mobile device of the driver.

Speed limit-enforcing method 800 proceeds with step 840, in which step the driver-application 718b of the intended driver, running on the user-smart-mobile device 702b of that driver, begins the monitoring process of the driving parameters of the driver. The monitoring process includes downloading the driver's profile, receiving legal speed limit changes and sending current location of the personal user-smart-mobile device 702b of the monitored driver, assumed to be in a moving vehicle. If the motion speed remains below a preconfigured velocity (step 850), for a preset threshold time interval, it is assumed the driving session is terminated, and driver-application 718b sends (step 860) a final report and terminates the activity of driver-application 718b. Then return to step 810, to thereby awaiting the resumption of the driving activity of the intended driver.

It should be noted that a driving profile for the master user may be set and kept in the drivers' DB (120, 720) facilitating the master user to monitor his/her own driving activity.

The invention being thus described in terms of several embodiments and examples, it will be obvious that the same may be varied in many ways. Such variations are not to be regarded as a departure from the spirit and scope of the invention, and all such modifications as would be obvious to one skilled in the art.

1. A speed-limit-enforcing system for enforcing a speed limit on a vehicle hosting the system, the system comprising:
a speed-limit controller;
a drivers' profile DB;
a driver-identifier; and
a throttle controller,
wherein said speed-limit controller activates said driver-identifier to identify the current driver of the vehicle;
wherein said drivers' profile DB comprises a speed-limit profile of the current driver;
wherein said speed-limit profile of each driver is predefined by a master user of the speed-limit enforcing system, and wherein the drivers may not alter any of said speed-limit profiles;
wherein said speed-limit controller is a personal user-smart-mobile device, having a driver-application running thereon;
wherein said speed-limit controller derives a current speed limit from rules defined in said speed-limit profile of said identified current driver; and
wherein said speed-limit controller is adapted to activate said throttle controller to limit the fuel supply to the engine of the vehicle, such that the current velocity of the vehicle, provided by an external source, does not exceed said current speed limit.

2. The speed-limit-enforcing system of claims 1 further comprises one or more warning devices, wherein when said current velocity of the vehicle exceeds said current speed limit, said speed-limit controller activates at least one of said warning devices to warn the current driver.

3. The speed-limit-enforcing system of claim 2, wherein at least one of said warning devices is selected from the group including: a speaker, a light, a display wherein at least one of said warning devices is activated in an intensity that is directly related to the difference in speed between said current velocity of the vehicle and said current speed limit.

4. (canceled)

5. The speed-limit-enforcing system of claim 1, wherein said external source is a GPS unit and wherein said speed-limit controller retrieves said current velocity of the vehicle and the geographical location of the current road, on which road the vehicle is being driven on, from said GPS unit.

6. The speed-limit-enforcing system of claims 5 further comprises a map-memory-storage containing map data, including the maximum legal speed limit of said current road, wherein at least one of said rules, defined in said speed-limit profile of the current driver, relates to said maximum legal speed limit of said current road, and wherein said map-memory-storage is a local device or a remote database.

7. (canceled)

8. The speed-limit-enforcing system of claim 1, wherein at least one of said rules, defined in said speed-limit profile of the current driver, relates to a velocity selected from the group including the maximum legal speed allowed in the country and the maximum urban speed allowed, if urban/country geographical data location is known.

9. The speed-limit-enforcing system of claim 1, wherein said throttle controller is an accelerating-pedal-control apparatus, and wherein said speed-limit controller is adapted to activate an electric motor for setting the position of a stopper, to thereby limit the depression range of the accelerator pedal.

10. (canceled)

11. The speed-limit-enforcing system of claims 1 further comprises a display for displaying data.

12. (canceled)

13. The speed-limit-enforcing system of claim 11, wherein said display is a touch screen, enabling entering input to said speed-limit controller.

14. (canceled)

15. The speed-limit-enforcing system of claim 1, wherein said driver-identifier is a fingerprint reader.

16. (canceled)

17. The speed-limit-enforcing system of claim 6 further including a master-smart-mobile device, having a master-application running thereon.

18. The speed-limit-enforcing system of claim 17, wherein said personal user-smart-mobile device and said master-smart-mobile device are personal smart phones.

19. The speed-limit-enforcing system of claim 17, wherein said master-application facilitates the master user to turn on an activation mode.

20. The speed-limit-enforcing system of claim 17, wherein said external source is a GPS unit integrated into said personal user-smart-mobile device and said master-smart-mobile device, and wherein said speed-limit controller retrieves said current velocity of the vehicle and the geographical location of the current road, on which road the vehicle is being driven on, from said GPS unit.

21. The speed-limit-enforcing system of claim 6 further comprises a map-memory-storage containing map data, including the maximum legal speed limit of said current road, wherein at least one of said rules, defined in said speed-limit profile of the intended driver, relates to said maximum legal speed limit of said current road, and wherein said map-memory-storage is a local device or a remote database.

22. (canceled)

23. The speed-limit-enforcing system of claim 17, wherein the vehicle includes a vehicular wireless communication means, having an ID, such as Bluetooth (BT), wherein said master-smart-mobile device of the master user is adapted to obtain the ID of the vehicular wireless communication means and to transmit the ID of the vehicular wireless communication means to the remote server, to thereby record the ID of the vehicular wireless communication means in a designated location in the remote server;
wherein when utilizing the vehicle, said personal user-smart-mobile device of the intended driver is in communication flow with the vehicular wireless communication means;
wherein said personal user-smart-mobile device is adapted to obtain the ID of the vehicular wireless communication means; and
wherein said personal user-smart-mobile device is adapted to verify the read ID with said ID records created by the master user in said designated location in the remote server.

24. The speed-limit-enforcing system of claim 23, wherein said master smart-mobile device is adapted to read the ID of the vehicular from said driver to thereby identify the vehicle and the intended driver and wherein upon said identification of the intended driver, said activation mode is turned on automatically.

25. (canceled)

26. The speed-limit-enforcing system of claim 24, wherein when said activation mode is turned on, said driver-application is adapted to monitor and transmit driving parameters of the driving activity of the vehicle to said remote server and thereby also to said master-smart-mobile device.

27. A method for enforcing a speed limit, operable on a speed-limit-enforcing system disposed in a host vehicle and having a speed-limit controller, a throttle controller for controlling the rate at which gas is supplied to the engine of the vehicle, a driver-identifier, a drivers' profile DB and a at least one warning device, the method comprises the steps of:
obtaining the current velocity of the vehicle from an external source;
identifying the current driver of the vehicle using said driver-identifier-;
obtaining the speed-limit profile of said current driver from said drivers' profile DB;
determining the current speed-limit from rules defined in said speed-limit profile of said current driver;
comparing said current velocity of the vehicle with said current speed limit; and
when said current velocity of the vehicle exceeds said current speed limit:
turning on said at least one warning device; and/or
activating said speed-limit controller to limit the fuel supply to the engine of the vehicle, such that the velocity of the vehicle does not exceed said current speed limit, wherein said speed-limit controller is a personal user-smart-mobile device, having a driver-application running thereon.

28. The method of claim 27 further comprising the step of: a) obtaining the legal speed limit of the road on the vehicle is being driven on, wherein at least one of said rules, defined in said speed-limit profile of the current driver, relates to said maximum legal speed limit of said current road.

29. The method of claim 27, wherein said throttle controller is an accelerating-pedal-control apparatus, wherein said speed-limit controller is adapted to activate an electric motor for setting the position of a stopper, to thereby limit the depression range of the accelerator pedal, and wherein said activating of said speed-limit controller to limit the fuel supply to the engine of the vehicle, and wherein the method further comprises the steps of:
moving said stopper by a preconfigured distance to thereby reduce the fuel supply to the engine of the vehicle;
obtaining again the current velocity of the vehicle;
comparing said current velocity of the vehicle with said current speed limit, wherein:
when said current velocity of the vehicle does not exceed said current speed limit, perform the steps of activating said speed-limit controller to allow full range depression of the accelerator pedal, turning off the activated warning devices and exit; else
when said current velocity of the vehicle exceed said current speed limit and does not exceed the previously measured vehicle velocity, perform moving said stopper by a preconfigured distance to thereby reduce the fuel supply to the engine of the vehicle and obtaining again the current velocity of the vehicle.

30. The method of claim 29, wherein said current velocity of the vehicle exceed said current speed limit and when said current velocity of the vehicle exceeds the previously measured vehicle velocity, perform the steps of:
when an override is available in the rules of the speed-limit profile of said current driver, activating said speed-limit controller to allow full range depression of the accelerator pedal, turning off the activated warning devices and exit;
else, when an override is not available in the rules of the speed-limit profile of said current driver, perform the step of:
intensifying the output of said at least one warning device; and/or
activating said throttle controller to limit the fuel supplied to the engine of the vehicle by a preconfigured extent.
